(19) United States
(12) Patent Application Publication
(10) Pub. No.: US 2022/0320983 A1
(43) Pub. Date: Oct. 6, 2022

(54) MOTOR AND ELECTRICAL PRODUCT

(71) Applicant: NIDEC CORPORATION, Kyoto (JP)

(72) Inventors: Shunsuke MURAKAMI, Kyoto (JP); Hiroshi SAMBUICHI, Kyoto (JP)

(73) Assignee: NIDEC CORPORATION, Kyoto (JP)

(21) Appl. No.: 17/707,986

(22) Filed: Mar. 30, 2022

(30) Foreign Application Priority Data
Mar. 31, 2021 (CN) 202110346143.8

(51) Int. Cl. H02K 24/00; H02K 11/21

(52) U.S. Cl. CPC H02K 24/00; H02K 11/21

(57) ABSTRACT

A motor includes: a rotor arranged in a rotatable manner centered on a central axis and having a shaft and a rotor core arranged around the shaft; a stator arranged to face the rotor in a radial direction; a detector in which at least a portion is located on one side of the rotor core in an axial direction; and a housing accommodating the rotor, the stator, and the detector. The detector has a tubular fixed portion fixed to the rotor and an extending portion extending from an upper side of the fixed portion in the axial direction toward an outer side of the fixed portion in the radial direction. The extending portion is located on one side of the rotor core in the axial direction. At least a portion of the extending portion and the rotor are in contact with each other in the axial direction.

### CROSS REFERENCE TO RELATED APPLICATIONS

The present invention claims priority under 35 U.S.C. § 119 to Chinese Application No. 202110346143.8 filed on Mar. 31, 2021 the entire content of which is incorporated herein by reference.

### FIELD OF THE INVENTION

An example of the present application relates to the mechanical and electrical field, and particularly to a motor and an electrical product.

### BACKGROUND

In a conventional motor structure, a detector and a rotor are positioned in a radial direction, but the positioning in an axial direction is not performed. When the motor rotates at a high speed or is subjected to an impact, a vibration in the axial direction of a detection portion of the detector is likely to occur, which leads to an influence on the detection performance.

It should be noted that the above description of the technical background only describes the technical solution of the present application clearly and thoroughly and facilitates the understanding of those skilled in the art. The above technical solution should not be considered known to those skilled in the art solely because these solutions are described in the related art part of the present application.

### SUMMARY

One aspect of the example of the present application provides a motor, including:

a rotor that is arranged in a rotatable manner centered on a central axis and has a shaft and a rotor core arranged around the shaft;
a stator arranged so as to face the rotor in a radial direction;
a detector in which at least a portion is located on one side of the rotor core in an axial direction; and
a housing that accommodates the rotor, the stator, and the detector;
wherein the detector has a tubular fixed portion fixed to the rotor and an extending portion extending from an upper side of the fixed portion in the axial direction toward an outer side of the fixed portion in the radial direction; and
the extending portion is located on one side of the rotor core in the axial direction, and at least a portion of the extending portion and the rotor are in contact with each other in the axial direction.

Another aspect of the example of the present application provides an electrical product having the motor according to any one of the above examples.

The above and other elements, features, steps, characteristics and advantages of the present disclosure will become more apparent from the following detailed description of the preferred embodiments with reference to the attached drawings.

### BRIEF DESCRIPTION OF THE DRAWINGS

The appended drawings are used to provide a further understanding on an example of the present application, and are used to constitute a part of the specification, illustrate an exemplary embodiment of the present application, and explain the principles of the present application along with text description. Obviously, the drawings in the following description are only some examples of the present application, and those skilled in the art may obtain other drawings based on these drawings even without creative labor. In the drawings,

FIG. 1 is a schematic diagram of an example of a motor according to the example of the present application;

FIG. 2 is a schematic diagram of an axial cross section of the motor shown in FIG. 1;

FIG. 3 is a schematic diagram of an example of a detector of the motor shown in FIG. 1;

FIG. 4 is a plan view of the detector shown in FIG. 3; and

FIG. 5 is a schematic diagram of an axial cross section of the detector shown in FIG. 3.

### DETAILED DESCRIPTION

With reference to the drawings, the above-described features and other features of the present application are clarified by the following specification. An exemplary embodiment of the present application, which represents some exemplary embodiments in which the principles of the present application may be adopted, is specifically disclosed in the specification and drawings. It should be understood that the present application is not limited to the described exemplary embodiment, and the present application includes all modifications, variations, and equivalents that fall within the scope of the attached claims.

In the example of the present application, the expression “and/or” includes any one or all combinations of one type or plural types of terms listed in connection therewith. The expression such as “contain”, “include”, “have” and the like refer to the existence of the stated feature, element, component part, or assembly, but do not exclude the presence or addition of one or a plurality of other features, elements, component parts, or assemblies.

In the example of the present application, the singular form such as “one”, “this” or the like may include the plural form. For example, “one kind of” or “one type of” should be broadly understood and is not limited to the meaning of “one”. In addition, the expression “the . . . mentioned above” should be understood to include both the singular form and the plural form unless otherwise specified before and after. Also, the expression “according to” should be understood as “at least partially . . . according to” and the term “based on” should be understood as “at least partially . . . based on” unless otherwise stated before and after.

Note that, in the following description of the present application, for convenience of description, a direction extending along a central axis O of a motor or a direction parallel to the central axis O is referred to as “axial direction”; a direction oriented to an opening of a motor housing from the bottom of the motor housing is referred to as “above”, “upper side”, “upper side in the axial direction” or “one side in the axial direction”; a direction oriented to the bottom of the motor housing from the opening of the motor housing is referred to as “below”, “lower side”, “lower side in the axial direction” or “the other side in the axial direction”; a radius direction centered on the central axis O is referred to as “radial direction”; a direction of getting close to the central axis O is referred to as “inner side in the radial direction”; a direction of getting away from the central axis O is referred to as “outer side in the radial direction”; and a direction surrounding the central axis O is referred to as “circumferential direction”. However, it is worth noting that these are only used for convenience of description and do not limit the orientation of the motor during use and manufacture.

Hereinafter, the embodiment of the example of the present application is described with reference to the drawings.

The example of the present application provides a motor.

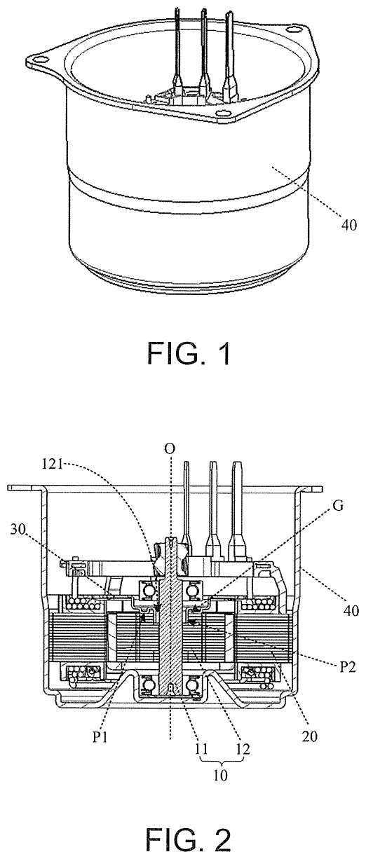

FIG. 1 is a schematic diagram of an example of the motor according to the example of the present application, and FIG. 2 is a schematic diagram of an axial cross section of the motor shown in FIG. 1. As shown in FIGS. 1 and 2, the motor includes: a rotor 10 that is arranged in a rotatable manner centered on a central axis O and has a shaft 11 and a rotor core 12 arranged around the shaft 11; a stator 20 arranged so as to face the rotor 10 in a radial direction; a detector 30 in which at least a portion is located on one side of the rotor core 12 in an axial direction; and a housing 40 that accommodates the rotor 10, the stator 20, and the detector 30.

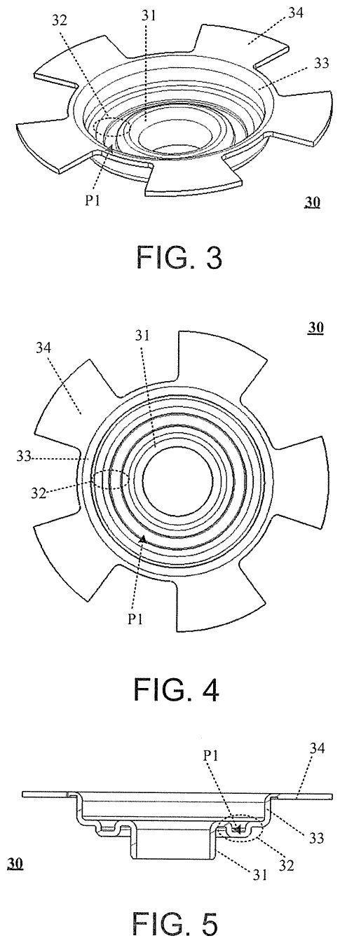

FIG. 3 is a schematic diagram of one detector of the motor shown in FIG. 1, FIG. 4 is a plan view of the detector shown in FIG. 3, and FIG. 5 is a schematic diagram of an axial cross section of the detector shown in FIG. 3. As shown in FIGS. 3 to 5, in the example of the present application, the detector 30 has a tubular or substantially tubular fixed portion 31 fixed to the rotor 10 and an extending portion 32 extending from the upper side of the fixed portion 31 in the axial direction toward the outer side of the fixed portion 31 in the radial direction. The extending portion 32 is located on one side of the rotor core 12 in the axial direction, and at least a portion P1 of the extending portion 32 and the rotor 10 are in contact with each other in the axial direction.

According to the example of the present application, by bringing at least a portion of the extending portion of the detector into contact with the rotor in the axial direction, the detector is positioned in the axial direction, the vibration of the detector in the axial direction is avoided, and the stability of the detector is improved.

In the above example, the fixed portion 31 is fixed to the rotor core 12 of the rotor 10, as shown in FIG. 2. However, the present application is not limited thereto, and the fixed portion 31 may be fixed to the shaft 11 of the rotor 10 if necessary. The specific fixing method is not limited in the present application.

In some examples, as shown in FIG. 2, at least the portion P1 of the extending portion 32 and the rotor core 12 of the rotor 10 are in contact with each other in the axial direction.

Thereby, the stability of the detector is improved.

In some examples, as shown in FIG. 2, at least a portion P2 of the fixed portion 31 and the rotor core 12 overlap each other in the radial direction. That is, when viewed along the radial direction, at least the portion P2 of the fixed portion 31 falls within a projection range of the rotor core 12. Thereby, the detector 30 is more easily brought into contact with the stator core 12, and a dimension of the motor in the axial direction is reduced.

In some examples, as shown in FIG. 2, an upper surface of the rotor core 12 in the axial direction has a first concave portion 121 recessed downward in the axial direction, and at least the portion P2 of the fixed portion 31 is inserted into the first concave portion 121 and is tightly fitted to the rotor core 12. Thereby, the positioning in the radial direction between the detector 30 and the rotor 10 is realized.

In some examples, although not shown in the drawing, a lower surface of the rotor core 12 in the axial direction has a second concave portion recessed upward in the axial direction, and the second concave portion and the first concave portion 121 face each other in the axial direction. Besides, a depth of the second concave portion may be set to be the same as a depth of the first concave portion 121. Thereby, the weight of the motor is reduced, and additionally, when the rotor core 12 is arranged, it is not necessary to distinguish between the upper side and the lower side of the rotor core 12, which further facilitates manufacture and installation and saves man-hours.

In some examples, as shown in FIG. 2, an outer periphery of at least the portion P2 of the fixed portion 31 and an inner periphery of the rotor core 12 are tightly fitted to each other, and there is an interval G between a portion of the extending portion 32 in contact with the fixed portion 31 and the rotor core 12 in the axial direction. Thereby, by arranging the above interval G at a position where the extending portion 32 and the fixed portion 31 are in contact with each other, it is possible to prevent the rotor core 12 and a R-angle of the detector 30 from coming into contact with each other and damaging the detector.

In some examples, as shown in FIGS. 3 to 5, the detector 30 further includes:

a connection portion 33 extending from the outer side of the extending portion 32 in the radial direction toward one side of the extending portion 32 in the axial direction; and
a detection portion 34 extending from one side of the connection portion 33 in the axial direction toward the outer side of the connection portion 33 in the radial direction, and having a plurality of gaps distributed at equal intervals in a circumferential direction.

In the above example, as shown in FIGS. 2 and 5, the portion P1 of the extending portion 32 in contact with the rotor 10 in the axial direction is located on the inner side of the connection portion 33 in the radial direction. Thereby, the contact between the detector 30 and the rotor 10 is further strengthened, and the stability of the detector is improved.

It is worth noting that the above description is only an exemplary description of the configuration of the motor related to the present application, the present application is not limited thereto, and appropriate variations may be made based on each of the above examples. In addition, the above description is only an exemplary description of each member, the present application is not limited thereto, and related techniques may be referred to for the specific contents of each member. In addition, members not shown in FIGS. 1 to 7 may be added, or one or a plurality of members in FIGS. 1 to 5 may be reduced. As for other configurations and structures of the motor, related techniques may be referred to, and the description is omitted herein.

According to the example of the present application, by bringing at least a portion of the extending portion of the detector into contact with the rotor in the axial direction, the detector is positioned in the axial direction, the vibration of the detector in the axial direction is avoided, and the stability of the detector is improved.

An example of the present application provides an electrical product having the motor described in the example of the first aspect. The structure of the motor is described in detail in the example of the first aspect, the contents thereof are incorporated here, and thus the description thereof is omitted here.

In the example of the present application, the electrical product may be any electrical equipment in which a motor is installed For example, the electrical product may be a household electrical appliance such as an indoor unit of an air conditioner, an outdoor unit of an air conditioner, a water supply machine, a washing machine, a vacuum cleaner, a compressor, a blower, and a mixer, may be industrial equipment such as a pump, a conveyor, an elevator, a standard industrial general-purpose mounter, a wind generator, a grinder, a traction motor, or various information processing equipment, and may be each member of an automobile such as an electric power steering system of an automobile, a sunroof adjuster of an automobile, a seat adjuster, a transmission, and a brake device.

Although the present application has been described above in association with the exemplary embodiment, those skilled in the art should understand that these descriptions are all exemplary and are not restrictions on the scope of protection of the present application. Those skilled in the art may make various variations and modifications to the present application based on the gist and principle of the present application, and these variations and modifications are also within the scope of the present application.

The exemplary embodiments of the present application have been described above with reference to the drawings. Many features and advantages of these exemplary embodiments are obvious according to the detailed specification. Therefore, the attached claims are to cover all those features and advantages of these exemplary embodiments that fall within the true gist and scope. Moreover, because those skilled in the art are able to easily conceive of many modifications and changes, the exemplary embodiments of the present application are not limited to the precise structures and operations as illustrated and described, and encompass all suitable modifications and equivalents that fall within the scope thereof.

Features of the above-described preferred embodiments and the modifications thereof may be combined appropriately as long as no conflict arises. While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor, comprising:
a rotor that is arranged in a rotatable manner centered on a central axis and has a shaft and a rotor core arranged around the shaft;
a stator arranged so as to face the rotor in a radial direction;
a detector in which at least a portion is located on one side of the rotor core in an axial direction; and
a housing that accommodates the rotor, the stator, and the detector;
wherein the detector has a tubular fixed portion fixed to the rotor and an extending portion extending from an upper side of the fixed portion in the axial direction toward an outer side of the fixed portion in the radial direction; and
the extending portion is located on one side of the rotor core in the axial direction, and at least a portion of the extending portion and the rotor are in contact with each other in the axial direction.

2. The motor according to claim 1, wherein at least the portion of the extending portion and the rotor core of the rotor are in contact with each other in the axial direction.

3. The motor according to claim 2, wherein at least a portion of the fixed portion and the rotor core overlap each other in the radial direction.

4. The motor according to claim 3, wherein an upper surface of the rotor core in the axial direction has a first concave portion recessed downward in the axial direction, and at least the portion of the fixed portion is inserted into the first concave portion and is tightly fitted to the rotor core.

5. The motor according to claim 4, wherein a lower surface of the rotor core in the axial direction has a second concave portion recessed upward in the axial direction, and the second concave portion and the first concave portion face each other in the axial direction.

6. The motor according to claim 3, wherein an outer periphery of at least the portion of the fixed portion and an inner periphery of the rotor core are tightly fitted to each other; and
there is an interval between a portion of the extending portion in contact with the fixed portion and the rotor core in the axial direction.

7. The motor according to claim 1, wherein the detector further comprises
a connection portion extending from an outer side of the extending portion in the radial direction toward one side of the extending portion in the axial direction, and
a detection portion extending from one side of the connection portion in the axial direction toward an outer side of the connection portion in the radial direction, and having a plurality of gaps distributed at equal intervals in a circumferential direction; and
a portion of the extending portion in contact with the rotor in the axial direction is located on an inner side of the connection portion in the radial direction.

8. An electrical product, comprising the motor according to claim 1.
